(19) United States
(12) Patent Application Publication
(10) Pub. No.: US 2006/0103888 A1
(43) Pub. Date: May 18, 2006

(54) Image data decoding apparatus and method

(76) Inventors: Hyun Ki Min, Seoul (KR); Yong Bum Cho, Seoul (KR)

Correspondence Address: Song K. Jung;MCKENNA LONG & ALDRIDGE LLP, 1900 K Street, N.W., Washington, DC, 20006, US

(21) Appl. No.: 11/270,463

(22) Filed: Nov. 10, 2005

(30) Foreign Application Priority Data
Nov. 12, 2004 (KR) 10-2004-0092376

(51) Int. Cl. H04N 1/41

(52) U.S. Cl. 358/426.02

(57) ABSTRACT

An image data decoding apparatus and method assures rapid decoding and displaying of image data stored at an external storage device. A controller for decoding the image data is divided into a main controller and a sub-controller. The sub-controller serves to store the image data transferred from a storage device at an image buffer. The main controller functions to transfer the image data stored at the image buffer to a decoding buffer and controls a decoder to decode the image data. The sub-controller's operation of transferring the image data stored at the storage device to the image buffer and the main controller's operation of causing a decoder to decode the image data can be performed simultaneously, thus allowing faster decoding and displaying of the image data.

This application claims the benefit of the Korean Patent Application No. P2004-0092376, filed on Nov. 12, 2004, which is hereby incorporated by reference for all purposes as if fully set forth herein.

### FIELD OF THE INVENTION

The present invention is directed to an image data decoding apparatus and method adapted to rapidly decode image data stored in a given storage device and display the decoded data on a screen.

### BACKGROUND OF THE INVENTION

Along with the development of digital technology, an image display apparatus such as a set-top box, a television set or the like has a tendency to deviate from a simple function of receiving broadcasting signals and is reborn as an apparatus of multiple nature holding a variety of complex added functions. For instance, a Personal Video Recorder (PVR) has been developed and currently in use incorporating a hard disk driver in an image display apparatus in order to store broadcasting signals at the hard disk driver as they are received. Also a memory card slot is added to the image display apparatus to provide a supplementary function of reproducing image data of, e.g., photographs, or MP3 files from a storage device such as a memory card removably mounted to the memory card slot.

In company with fast dissemination of digital cameras which have gained cyclonic popularity in recent years, an increasing need has surfaced in the conventional image display apparatus for a function of reproducing pictures taken by the digital cameras, with a memory card slot incorporated in the image display apparatus.

Such a multi-functional and multi-purpose image display apparatus requires the use of hardware of higher standard, thus making the image display apparatus costly to manufacture and hence increasing the economic burden to consumers.

For that reason, it is of paramount importance to draw out latent performance from the hardware currently in use in the image display apparatus to the utmost, while avoiding upgrading the hardware as far as possible.

One of the variety of functions that most intensively compel upgrading the hardware in an image display apparatus is the task of decoding, and displaying on a screen, image data of photographs and the like stored at a storage memory device such as a memory card which is removably fitted to a memory card slot of the image display apparatus.

With a view to storing as much image data as possible at a storage device with the use of limited storage capacity, the image data are usually encoded in a specified format and then stored at the storage device inclusive of the memory card. This means that decoding is essential and very important for the image display apparatus to display the image data stored at the storage device on a screen.

Conventionally, the encoded image data stored at the storage device were decoded through the use of an existing library as it stands. In other words, the image data kept at the storage device are stored at a buffer and decoding is conducted for the image data thus stored. Once the decoding operation for the first stored image data comes to an end, the next image data are stored at the buffer from the storage device and then decoded. Such a storing and decoding operation is performed repeatedly.

It is a matter of course that the time consumed in reading out and storing the image data at the buffer should affect the total time for decoding and displaying the image data on a screen.

To be more specific, if the image data of the storage device are read out and stored at the buffer at a reduced speed, the total time is increased for decoding and displaying the image data on the screen. The faster the time to read out the image data and store them at the buffer, the shorter the total time required in decoding and displaying the image data on the screen.

Due to these features of a storage device, the prior art image display apparatus tends to respond to a command of a user at different speeds, which makes the user feel inconvenient. Additionally, if a storage device employed is of bad performance, data processing speed becomes quite slow, thereby giving the user stuffy feeling. Urgent improvement is therefore needed to correct the disadvantages inherent in the prior art apparatus.

### SUMMARY OF THE INVENTION

It is an object of the present invention to provide an image data decoding apparatus and method that has a minimized dependency on a speed where image data are read out from a storage device and stored at a buffer and is capable of rapidly decoding and displaying the image data on a screen.

With this object in view, according to an image data decoding apparatus and method of the present invention, a controller for decoding image data is divided into a main controller and a sub-controller. The sub-controller serves to store the image data transferred from a storage device at a buffer. The main controller performs the task of causing the image data stored at the buffer to be decoded.

Accordingly, the present invention assures that the operation of storing the image data transferred from the storage device at the buffer and the operation of decoding the image data stored at the buffer can be performed simultaneously.

In accordance with the present invention, there is provided an image data decoding apparatus comprising: a storage device for storing encoded image data; a buffer for storing the image data transferred from the storage device in preparation for decoding: a decoder for decoding the image data stored at the buffer; a main controller for requesting the image data of the storage device to be stored at the buffer; and for controlling the decoder to decode the image data stored at the buffer; and a sub-controller for causing the image data of the storage device to be stored at the buffer in response to the request from the main controller.

The storage device is a memory device selected from the group consisting of a memory card or a Universal Serial Bus (USB) memory.

An interface part for transferring the image data stored at the storage device is provided between the storage device and the buffer. The interface part comprises a memory card slot to which the storage device is mounted. The interface part is adapted to transfer the image data through a Universal Serial Bus (USB), a Serial Advanced Technology Attachment (SATA) or a Parallel Advanced Technology Attachment (PATA).

The buffer comprises: an image buffer for storing the image data transferred from the storage device under a control of the sub-controller; and a decoding buffer for storing the image data transferred from the image buffer in preparation for decoding under a control of the main controller.

In one aspect, an image data decoding method of the present invention comprises the steps of: causing a sub-controller to transfer preselected image data stored at a storage device to an image buffer; causing a main controller to transfer the image data transferred to the image buffer to a decoding buffer; and causing a decoder to decode and display on a screen the image data transferred to the decoding buffer under a control of the main controller.

The step of transferring the image data stored at the storage device to the image buffer is carried out in such a manner that the sub-controller transfers the image data to the image buffer from the storage device in response to an image data storage request of the main controller. If the main controller requests the sub-controller to store the image data, the sub-controller determines whether the image buffer is empty and transfers the image data to the image buffer from the storage device if the image buffer is determined to be empty.

The step of transferring the image data stored at the storage device to the image buffer is performed in such a manner that the sub-controller determines whether the image buffer is empty and transfers the image data to the image buffer from the storage device if the image buffer is determined to be empty.

The step of transferring the image data stored at the storage device to the image buffer is done in such a manner that the image data for a file selected by a user through a user interface part among files stored at the storage device is transferred to the image buffer from the storage device by the sub-controller. The file selection is made in such manner that the main controller causes the sub-controller to read out and display file names of the image data stored at the storage device and then the user selects one or more of the displayed file names through the user interface part.

In another aspect, an image data decoding method of the present invention comprises the steps of: causing a main controller to request a sub-controller to read out and display file names of image data stored at a storage device if a selection command for the storage device is inputted through a user interface part; causing the sub-controller to transfer from the storage device to an image buffer the image data of the file names selected by the user among the displayed file names; and causing the main controller to transfer the image data transferred to the image buffer to a decoding buffer, after which the decoding buffer is controlled to decode and display the image data on a screen.

The step of transferring the image data stored at the storage device to the image buffer is carried out in such a manner that the sub-controller transfers the image data to the image buffer from the storage device in response to an image data storage request of the main controller. If the main controller requests the sub-controller to store the image data, the sub-controller determines whether the image buffer is empty and transfers the image data to the image buffer from the storage device if the image buffer is determined to be empty.

The step of transferring the image data stored at the storage device to the image buffer is performed in such a manner that the sub-controller determines whether the image buffer is empty and transfers the image data to the image buffer from the storage device if the image buffer is determined to be empty.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a block diagram showing an image data decoding apparatus according to the present invention;

FIG. 2 is a flowchart illustrating operations carried out by a main controller in accordance with the present invention; and

FIG. 3 is a flowchart illustrating operations performed by a sub-controller in accordance with the present invention.

### DETAILED DESCRIPTION OF THE INVENTION

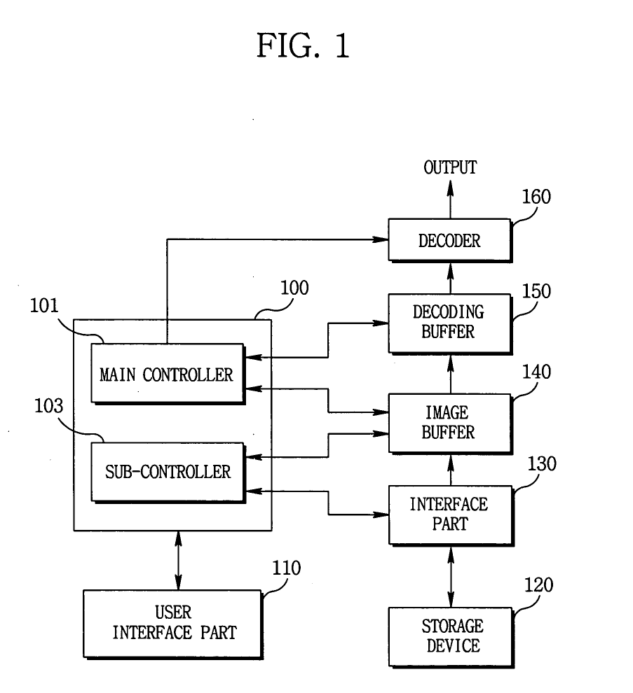

Referring to FIG. 1, a block diagram shows an image data decoding apparatus according to the present invention. In the figure, reference numeral 100 denotes a controller that performs the task of decoding image data. The controller 100 consists of a main controller 101 and a sub-controller 103. The main controller 101 controls decoding of the image data, whereas the sub-controller 103 controls transfer of the image data in response to a request from the main controller 101.

Reference numeral 110 designates a user interface part through which an operation command is inputted to the controller 100 by a user.

Designated by reference numeral 120 is a storage device that stores encoded image data. The storage device 120 comprises all kinds of storage means that can store the encoded image data, including a memory card widely used in digital cameras and a Universal Serial Bus (USB) memory, for instance.

Reference numeral 130 denotes an interface part provided with a memory card slot (not shown) to which the storage device 120 can be removably mounted from the outside. The interface part 130 allows the image data stored at the storage device 120 to be transferred through, e.g., a Universal Serial Bus (USB), a Serial Advanced Technology Attachment (SATA) or a Parallel Advanced Technology Attachment (PATA).

Indicated by reference numeral 140 is an image buffer that temporarily stores the image data. The image buffer 140 is adapted to store the image data transferred from the storage device 120 via the interface part 130 under a control of the sub-controller 103.

Reference numeral 150 designates a decoding buffer that stores the image data transferred from the image buffer 140 under a control of the main controller 101.

Reference numeral 160 denotes a decoder that decodes the image data stored at the decoding buffer 150 under a control of the main controller 101.

In operation of the inventive decoding apparatus as constructed above, the user mounts the storage device 120 to the memory card slot of the interface part 130 and manipulates the user interface part 110 to select the storage device 120. Responsive to this manipulation, the main controller 101 of the controller 100 requests the sub-controller 103 to provide file names of the entire data inclusive of the image data stored at the storage device 120.

In response to the request for provision of file names, the sub-controller 103 searches for the storage device 120 through the interface part 130 and extracts the file names thus found. The file names extracted by the sub-controller 103 are supplied to the main controller 101. The main controller 101 displays the file names received from the sub-controller 103 on a screen (not shown).

Under that state, if the user selects specific file names through the user interface part 110, the main controller 101 requests the sub-controller 103 to store the image data of the relevant file names at the image buffer 140. At this request, the sub-controller 103 controls the storage device 120 to transfer the image data corresponding to the file names, in response to which, the image data are transferred to the image buffer 140 from storage device 120 via the interface part 130 and stored at the image buffer 140 one after another.

Subsequently, the main controller 101 determines whether the image data are stored at the decoding buffer 150. In the event that the decoding buffer 150 contains no image data, the main controller 101 causes the image data stored at the image buffer 140 to be transferred to the decoding buffer 150 and requests the sub-controller 103 to store new image data transferred from the storage device 120 at the image buffer 140.

Under a control of the main controller 101, the decoder 160 decodes the image data stored at the decoding buffer 150, and the image data thus decoded are outputted and displayed on the screen.

In this manner, the main controller 101 controls the decoder 160 to decode the image data stored at the decoding buffer 150, during which time the sub-controller 103 controls the operation of storing the image data transferred from the storage device 120 at the image buffer 140.

As noted above, according to the present invention, the operation of storing the image data transferred from the storage device 120 at the image buffer 140 under a control of the sub-controller 103 and the operation of transferring the image data stored at the image buffer 140 to the decoding buffer 150 and causing the decoder 160 to decode the image data under a control of the main controller 101 are performed simultaneously. This makes sure that the image data stored at the storage device 120 can be rapidly decoded and displayed on the screen.

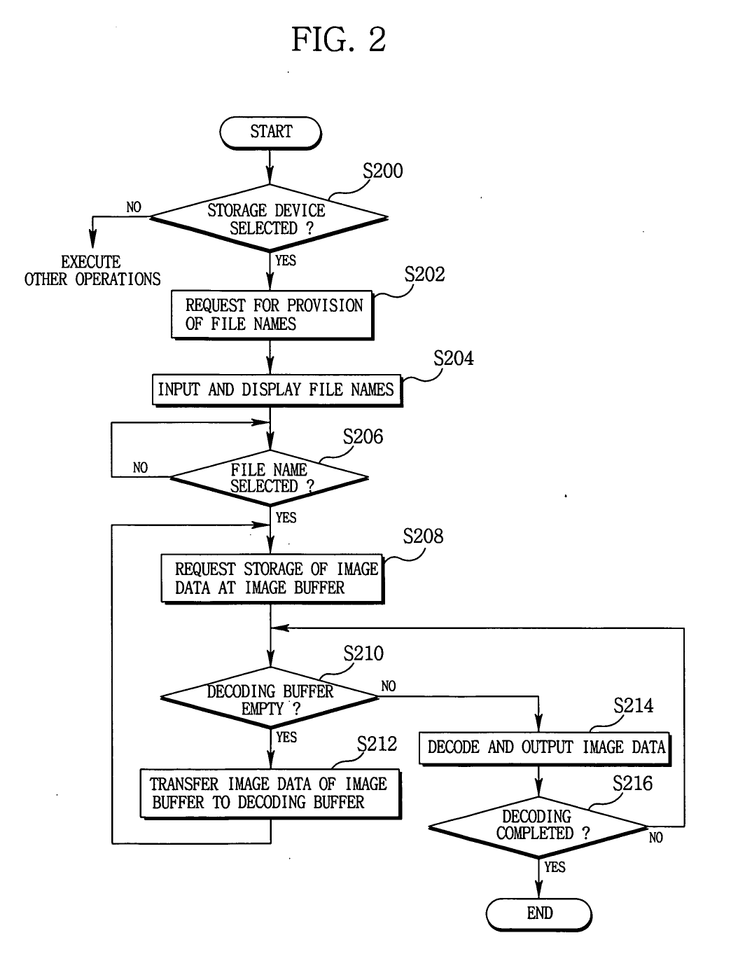

FIG. 2 is a flowchart illustrating operations carried out by the main controller in accordance with the decoding method of the present invention. As illustrated, if the user selects the storage device 120 through the user interface part 110 (S200), the main controller 101 requests the sub-controller 103 to provide file names of the entire data inclusive of the image data stored at the storage device 120 (S202).

Responsive to the request for provision of file names, the sub-controller 103 searches for the storage device 120 through the interface part 130 and extracts the file names thus found. The file names extracted by the sub-controller 103 are supplied to the main controller 101 which in turn displays the file names received from the sub-controller 103 on the screen not shown in the drawings (S204).

Under that state, the user selects specific file names through the user interface part 110 (S206), in response to which, the main controller 101 requests the sub-controller 103 to store the image data of the relevant file names selected by the user at the image buffer 140 (S208). At this request, the sub-controller 103 transfers the image data of the relevant file names stored at the storage device 120 to the image buffer 140 via the interface part 130 and then stores the image data at the image buffer 140.

Subsequently, the main controller 101 determines whether the decoding buffer 150 is empty (S210). As a result of determination at step S210 if the decoding buffer 150 is determined to be empty, the main controller 101 causes the image data stored at the image buffer 140 to be transferred to the decoding buffer 150 (S212). In other words, responsive to the image data storage request made at step S208, the sub-controller 103 transfers the image data stored at the image buffer 140 to the decoding buffer 150 via the interface part 130 (S212).

The image buffer 130 becomes empty as the image data stored at the image buffer 140 are transferred to the decoding buffer 150. Once again, the main controller 101 requests the sub-controller 103 to store the image data at the empty image buffer 140 (S208).

Then, the main controller 101 confirms that the image data are stored at the decoding buffer 150 (S210). Upon this confirmation, the main controller 101 controls the decoder 160 to decode all the image data stored at the decoding buffer 150 and causes the decoded image data to be outputted and displayed on the screen (S214).

Once the image data stored at the decoding buffer 150 are decoded completely, the main controller 101 determines whether the image data of the file names selected by the user were decoded in their entirety (S216). If it is determined that the image data of the file names selected by the user were not completely decoded as yet, the flow returns back to step S210 where the main controller 101 performs the decoding operation, during which time the sub-controller 103 stores all the image data of the image buffer 140 at the decoding buffer 150 (S212).

Subsequently, the main controller 101 requests the sub-controller 103 to store the image data at the image buffer 140 (S208) and repeatedly performs the operation of controlling the decoder 160 to decode the image data stored at the decoding buffer 150.

If the determination made at S216 indicates that the image data of the file names selected by the user were decoded in their entirety, the main controller 101 ceases to decode the image data.

According to the inventive method set forth above, in case the decoding buffer 150 is empty, the main controller 101 transfers the image data stored at the image buffer 140 to the decoding buffer 150 and requests the sub-controller 103 to store new image data at the image buffer 140. While the sub-controller 103 stores new image data at the image buffer 140, the main controller 101 controls the decoder 160 to decode the image data stored at the decoding buffer 150.

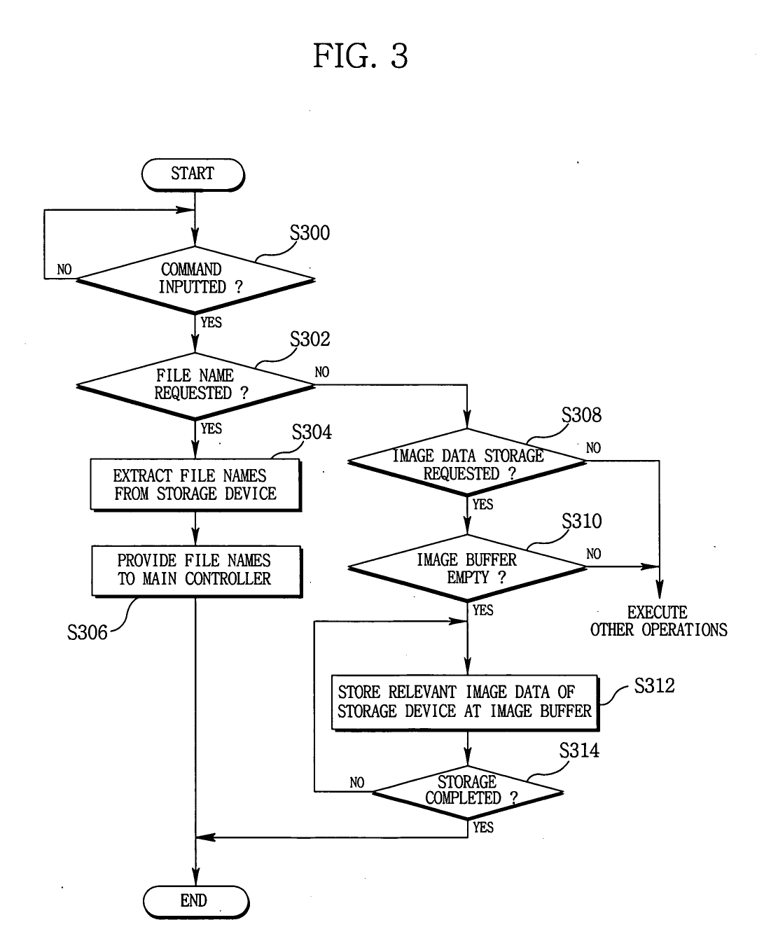

FIG. 3 is a flowchart illustrating operations performed by a sub-controller in accordance with the inventive decoding method. As illustrated, if a predetermined operation command is inputted to the sub-controller 103 from the main controller 101 (S300), the sub-controller 103 determines whether the input command is a request for provision of file names of the image data stored at the storage device 120 (S302).

If it is determined that the main controller 101 has requested provision of the file names, the sub-controller 103 extracts the file names of the image data stored at the storage device 120 (S304). As the file name extraction is finished, the sub-controller 103 provides the main controller 101 with the extracted file names so that the main controller 101 can display the file names on the screen at step S204 set out supra. Then the flow comes to an end.

If it is determined at step S302 that the input command is not a request for provision of file names, the sub-controller 103 determines whether the input command is a command that requests the image data of specific file names to be stored at the image buffer 140 (S308).

Should the input command be a command requesting the image data of specific file names to be stored at the image buffer 140, then the sub-controller 103 determines whether the image buffer 140 remains empty. If the image buffer 140 contains no image data, the sub-controller 103 stores the image data of the storage device 120 corresponding to the file names at the image buffer 140 via the interface part 130 (S312). The flow comes to an end when the image data have been stored at the image buffer 140 (S314).

In such a fashion, the sub-controller 103 controls the operation of storing the image data of the storage device 120 at the image buffer 140 in response to the request of the main controller 101, while the main controller 101 controls the decoder 160 to decode the image data.

According to the present invention described in the foregoing, the sub-controller 103 is devoted itself to storing the image data of the storage device 120 at the image buffer 140, and the main controller 101 performs only the operation of transferring the image data stored at the image buffer 140 to the decoding buffer 150 and then controlling the decoder 160 to decode the image data thus transferred. This assures that the sub-controller's operation of storing the image data of the storage device 120 at the image buffer 140 and the main controller's operation of controlling the decoder 160 to decode the image data stored at the decoding buffer 150 can be performed separately but simultaneously, thus making it possible to rapidly decode the image data contained in the storage device and display them on the screen.

Although certain preferred embodiments of the present invention have been described in detail, it will be apparent to those skilled in the art that various changes and modifications may be made thereto within the scope of the invention defined by the appended claims.

What is claimed is:

1. An image data decoding apparatus, comprising:
a buffer for storing encoded image data;
a decoder for decoding the image data stored at the buffer;
a main controller for requesting the image data to be stored at the buffer and for controlling the decoder to decode the image data stored at the buffer; and
a sub-controller for causing the image data to be stored at the buffer in response to the request from the main controller.

2. The apparatus as recited in claim 1, wherein the image decoding apparatus further comprises a storage device for storing the encoded image data.

3. The apparatus as recited in claim 2, wherein an interface for transferring the image data stored at the storage device is provided between the storage device and the buffer.

4. The apparatus as recited in claim 3, wherein the interface comprises a memory card slot, where the storage device mounts to the memory card slot.

5. The apparatus as recited in claim 3, wherein the interface is adapted to transfer the image data through a Universal Serial Bus (USB), a Serial Advanced Technology Attachment (SATA) or a Parallel Advanced Technology Attachment (PATA).

6. The apparatus as recited in claim 2, wherein the buffer comprises:
an image buffer for storing the image data transferred from the storage device controlled by the sub-controller; and
a decoding buffer for storing the image data transferred from the image buffer in preparation for decoding controlled by the main controller.

7. A method of decoding image data comprising:
transferring preselected image data stored at a storage device to an image buffer with a sub-controller;
transferring the image data from the image buffer to a decoding buffer with a main controller; and
decoding the image data transferred to the decoding buffer with a decoder, wherein the main controller controls the decoder; and
displaying the image data.

8. The method as recited in claim 7, wherein the main controller requests the sub-controller to transfer the image data stored at the storage device to the image buffer.

9. The method as recited in claim 8, wherein the sub-controller determines if the image buffer is empty when the main controller requests the sub-controller to store the image data.

10. The method as recited in claim 9, wherein the sub-controller transfers the image data to the image buffer from the storage device if the image buffer is determined to be empty when the main controller requests the sub-controller to store the image data.

11. The method as recited in claim 7, wherein the sub-controller determines if the image buffer is empty and transfers the image data to the image buffer from the storage device if the image buffer is empty.

12. The method as recited in claim 7, wherein the image data transferred by the sub-controller from the storage device to the image buffer corresponds to a selected file among a plurality of files stored at the storage device.

13. The method as recited in claim 11, wherein the main controller causes the sub-controller to read out and display file names of the image data stored at the storage device thereby enabling selection of the selected file from the plurality of files.

14. A method of decoding image data comprising:
requesting a sub-controller to read and display file names of image data stored at a storage device with a main controller;
transferring from the storage device to an image buffer image data of file names from the displayed file names with the sub-controller; and
transferring the image data from the image buffer to a decoding buffer with the main controller;
decoding the image data; and
displaying the image data.

15. The method as recited in claim 14, wherein the main controller requests the sub-controller to transfer the image data stored at the storage device to the image buffer.

16. The method as recited in claim 15, wherein the sub-controller determines if the image buffer is empty when the main controller requests the sub-controller to store the image data.

17. The method as recited in claim 16 wherein the sub-controller transfers the image data to the image buffer from the storage device if the image buffer is determined to be empty when the main controller requests the sub-controller to store the image data.

18. The method as recited in claim 14, wherein the sub-controller determines if the image buffer is empty and transfers the image data to the image buffer from the storage device if the image buffer is empty.

19. The apparatus as recited in claim 2, wherein the storage device is a Universal Serial Bus (USB) memory.

20. The apparatus as recited in claim 2, wherein the storage device is a memory card.
